(19) United States
(12) Patent Application Publication
(10) Pub. No.: US 2026/0105376 A1
(43) Pub. Date: Apr. 16, 2026

(54) METHODS AND SYSTEMS FOR ASSESSMENT OF FORECASTABILITY OF A TIME SERIES

(71) Applicant: Kinaxis Inc, Ottawa (CA)

(72) Inventor: Ashwin Puri, Kitchener (CA)

(73) Assignee: Kinaxis Inc., Ottawa (CA)

(21) Appl. No.: 19/355,554

(22) Filed: Oct. 10, 2025

Related U.S. Application Data
(60) Provisional application No. 63/706,093, filed on Oct. 11, 2024.

(51) Int. Cl. G06N 20/00

(52) U.S. Cl. CPC G06N 20/00

(57) ABSTRACT

Systems and methods are disclosed for assessing the forecastability of time series data using machine learning. A large set of time series is preprocessed and partitioned into training and testing sets. Multiple forecasting models are trained on the training data, and the best-performing model is used to compute a sample forecastability metric. Features are extracted from the time series and paired with the forecastability metric to train a predictive model. This trained model is then used to estimate the forecastability of new time series data based on extracted features, bypassing the need for computationally intensive forecasting. The approach enables efficient and reliable forecastability assessment across large volumes of time series data.

This application claims priority to U.S. Provisional Patent Application 63/706,093 filed on Oct. 11, 2024, which is incorporated herein in its entirety, by reference.

### BACKGROUND

When it comes to forecasting time series, it is generally impossible to achieve perfect predictions. This is because, for one, a time series can be decomposed into several components, one of which is a random component. Since this component is random, it is impossible to predict, and as such, introduces uncertainty into any forecast. A second reason why it is generally impossible to achieve perfect predictions, is that the forecasting models that are used, aim to estimate the true underlying process of the time series. However, since there is limited data available and since the true process can be extremely complicated, these forecasting models can only ever be estimates of the true process.

Consequently, if forecasts perform poorly, discerning why is not always a trivial task. Being able to do so would allow for the identification of one of two possibilities: the forecasts can be improved through the use of a different forecasting model; or the time series itself is too unpredictable and, therefore, improving the forecasts by use of different forecasting models is unfeasible. Being able to determine the source of error would allow identification of whether poor performance could be rectified with a more appropriate model, or would require information outside the given data. Understanding why a forecast performs poorly, would allow identification of whether poor forecast performance could be rectified with a more appropriate machine learning model, or would require information outside the given data. Without this understanding, computational resources may be expended unnecessarily to try to improve forecasting a time series that is inherently unpredictable.

Such discernment is based on being able to determine the forecastability of a time series—that is, determine a measure of an error of a forecast of the time series. Determination of forecastability is itself computationally intensive. There is a need for a method that can provide a measure of the forecastability of time series that is computationally less intensive and reliable.

### BRIEF SUMMARY

Disclosed herein are systems and methods that measure how well a time series can be forecasted, by developing a metric that measures how well a time series can be forecasted (which is termed the “forecastability” of a time series). Forecastability can be derived by examining the behavior of the time series (for example, looking for the presence and strength of seasonality, trend, outliers, and so forth) and subsequently using this analysis to determine how well the time series can be forecasted. In many applications, computational resources are used to forecast tens of thousands of time series using machine learning models.

Disclosed herein are systems and methods that begin with a large set of time series data; each series is partitioned into a training set and testing set. The training set of each series is used to train multiple machine learning models; each model outputs a forecast that is compared to the test set of the series. The most accurate forecast is compared to the test set, and a forecastability metric for that series is determined. The same training set is also used to generate features of the training set, resulting in features paired with a corresponding forecastability metric, for the series. Such paired data is computed for each time series in the entire set; the pairs are then used to train a machine learning model, which is then used to predict the forecastability of new time series data. As such, the computer-intensive procedure of calculating the forecastability of each new time series data is bypassed altogether. In additional the predicted forecastability obtained through these systems and methods is more reliable than calculating the forecastability, since the full data in the new time series is used to estimate the forecastability, as opposed to the full calculation, where the new time series data is partitioned into a training set and a testing set.

In one aspect, a computing apparatus is provided that includes a processor. The computing apparatus also includes a memory storing instructions that, when executed by the processor, configure the apparatus to receive a plurality of time series data, preprocess the time series data to generate preprocessed time series data, where preprocessing includes one or more operations selected from the group consisting of filtering, trimming, partitioning, normalization, and outlier handling, train a plurality of forecasting models on each of the preprocessed time series data, compute a forecastability metric for each time series based on performance of each of the forecasting models, extract a set of features from the preprocessed time series data, train a set of predictive models using the extracted features and the forecastability metric to learn a mapping from features to forecastability, select a predictive model based prediction accuracy, receive a new time series data, preprocess the new time series data using identical or similar preprocessing operations applied to the training data, to generate a preprocessed new time series data, extract features from the preprocessed new time series data, and predict a forecastability score for the new time series data using the predictive model.

The computing apparatus may also include where when preprocessing, the apparatus is further configured to remove time series that have fewer than a preset minimum number of periods, partition time series that have more than a preset maximum number of periods into smaller segments, and trim leading zeros and removing trailing zeros from the time series data.

The computing apparatus may also include where the plurality of forecasting models includes models selected from the group consisting of AutoARIMA, Exponential Smoothing (ETS), Complex Exponential Smoothing (CES), Theta Method, Croston's Method, Intermittent Seasonal Exponential Smoothing (ISES), Intermittent Demand Averaging (IDA), Extreme Gradient Boosting (XGB), Support Vector Regression (SVR), Linear Regression (LR), and Time-series Dense Encoder (TiDE).

The computing apparatus may also include where the sample forecastability score is computed as the minimum scaled loss across the forecasting model set on a holdout test set of a defined forecast horizon.

The computing apparatus may also include where predictive model is a Light Gradient Boosting Machine (LGBM) trained using Bayesian cross-validation for hyperparameter optimization.

The computing apparatus may also include where the set of features includes at least one of decomposition, autocorrelation, distribution, extreme value, trajectory, and intermittent. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer to receive a plurality of time series data, preprocess the time series data to generate preprocessed time series data, where preprocessing includes one or more operations selected from the group consisting of filtering, trimming, partitioning, normalization, and outlier handling, train a plurality of forecasting models on each of the preprocessed time series data, compute a forecastability metric for each time series based on performance of each of the forecasting models, extract a set of features from the preprocessed time series data, train a set of predictive models using the extracted features and the forecastability metric to learn a mapping from features to forecastability, select a predictive model based on prediction accuracy, receive a new time series data, preprocess the new time series data using identical or similar preprocessing operations applied to the training data, to generate a preprocessed new time series data, extract features from the preprocessed new time series data, and predict a forecastability score for the new time series data using the predictive model.

The non-transitory computer-readable storage medium may also include wherein when preprocessing, the instructions further configure the computer to remove time series that have fewer than a preset minimum number of periods, partition time series that have more than a preset maximum number of periods into smaller segments, and trim leading zeros and removing trailing zeros from the time series data.

The non-transitory computer-readable storage medium may also include where the plurality of forecasting models includes models selected from the group consisting of AutoARIMA, Exponential Smoothing (ETS), Complex Exponential Smoothing (CES), Theta Method, Croston's Method, Intermittent Seasonal Exponential Smoothing (ISES), Intermittent Demand Averaging (IDA), Extreme Gradient Boosting (XGB), Support Vector Regression (SVR), Linear Regression (LR), and Time-series Dense Encoder (TiDE).

The non-transitory computer-readable storage medium may also include where the sample forecastability score is computed as the minimum scaled loss across the forecasting model set on a holdout test set of a defined forecast horizon.

The non-transitory computer-readable storage medium may also include where the predictive model is a Light Gradient Boosting Machine (LGBM) trained using Bayesian cross-validation for hyperparameter optimization.

The non-transitory computer-readable storage medium may also include where the set of features includes at least one of decomposition, autocorrelation, distribution, extreme value, trajectory, and intermittent. Other technical features may be readily apparent to one skilled in the art from the following figures, descriptions, and claims.

In one aspect, a computer-implemented method is provided that includes receiving, by a processor, a plurality of time series data, preprocessing, by the processor, the time series data to generate preprocessed time series data, where preprocessing includes one or more operations selected from the group consisting of filtering, trimming, partitioning, normalization, and outlier handling, training, by the processor, a plurality of forecasting models on each of the preprocessed time series data, computing, by the processor, a forecastability metric for each time series based on performance of each of the forecasting models, extracting, by the processor, a set of features from the preprocessed time series data, training, by the processor, a set of predictive models using the extracted features and the forecastability metric to learn a mapping from features to forecastability, selecting, by the processor, a predictive model based on prediction accuracy, receiving, by the processor, a new time series data, preprocessing, by the processor, the new time series data using identical or similar preprocessing operations applied to the training data, to generate a preprocessed new time series data, extracting, by the processor, features from the preprocessed new time series data, and predicting, by the processor, a forecastability score for the new time series data using the predictive model.

The computer-implemented model may also include where preprocessing further includes at least one of: removing, by the processor, time series that have fewer than a preset minimum number of periods, partitioning, by the processor, time series that have more than a preset maximum number of periods into smaller segments, and trimming, by the processor, leading zeros and removing trailing zeros from the time series data.

The method may also include where the plurality of forecasting models includes models selected from the group consisting of AutoARIMA, Exponential Smoothing (ETS), Complex Exponential Smoothing (CES), Theta Method, Croston's Method, Intermittent Seasonal Exponential Smoothing (ISES), Intermittent Demand Averaging (IDA), Extreme Gradient Boosting (XGB), Support Vector Regression (SVR), Linear Regression (LR), and Time-series Dense Encoder (TiDE).

The method may also include where the sample forecastability score is computed as the minimum scaled loss across the forecasting model set on a holdout test set of a defined forecast horizon. The method may also include where the predictive model is a Light Gradient Boosting Machine (LGBM) trained using Bayesian cross-validation for hyperparameter optimization. The method may also include where the set of features includes at least one of decomposition, autocorrelation, distribution, extreme value, trajectory, and intermittent. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter may become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for assessment of forecastability of a time series in accordance with one embodiment.

FIG. 2 illustrates an overview in accordance with one embodiment.

FIG. 3 illustrates partitioning of a time series in accordance with one embodiment.

FIG. 4 illustrates a block diagram for machine learning training in accordance with one embodiment.

FIG. 5 illustrates data flow in a training phase in accordance with one embodiment.

FIG. 6 illustrates a block diagram for generating the forecastability of new time series in accordance with one embodiment.

FIG. 7 illustrates data flow in a prediction phase accordance with one embodiment.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit including custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, include one or more physical or logical blocks of computer instructions which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which includes one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

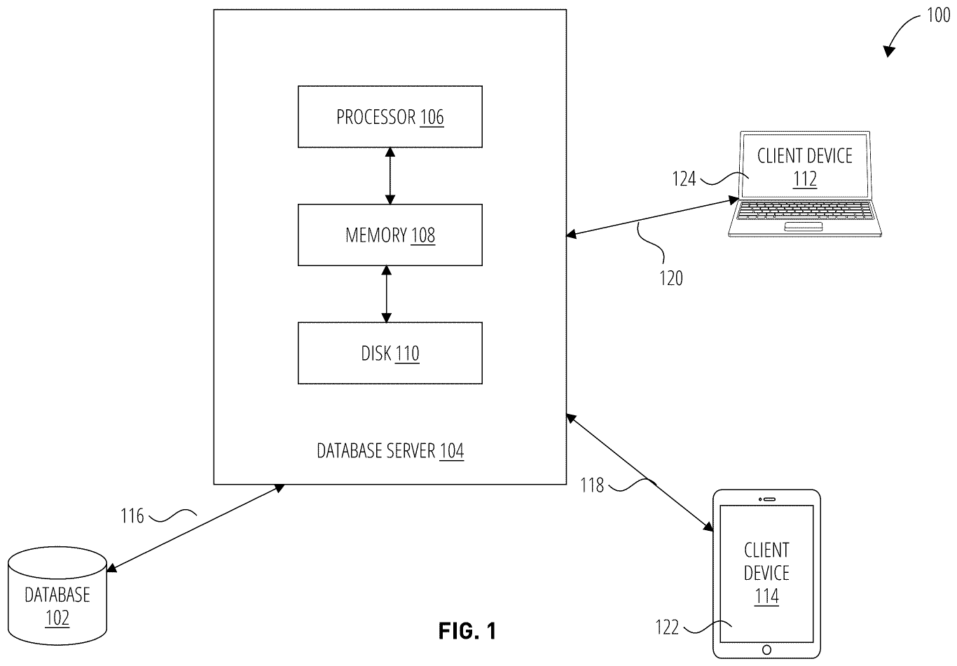

FIG. 1 illustrates an example of a system 100 for assessment of forecastability of a time series with one embodiment.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also include a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

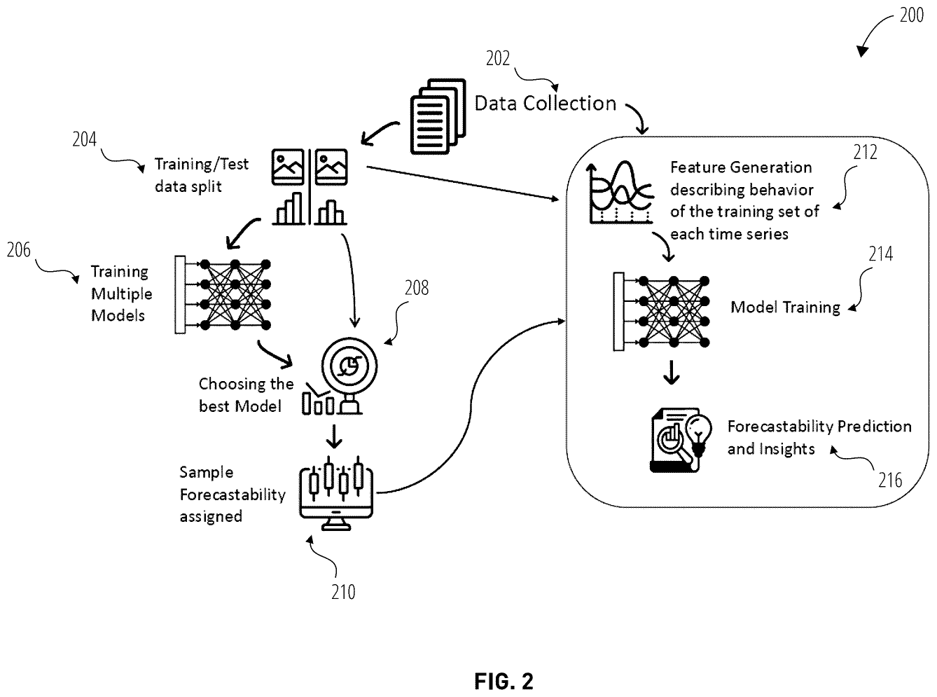

Methods and systems disclosed herein can include cloud instance, processing power (clusters), time series data, a comprehensive set of forecasting models, formulation of a metric to compute sample forecastability, generation of time series features, and a machine learning model to predict sample forecastability given the time series features. FIG. 2 illustrates an overview 200 in accordance with one embodiment.

Data collection 202 includes a large set of time series data. Each time series is partitioned into a training set and testing set at 204. The training set of each series is used to train multiple machine learning models at 206; each model outputs a forecast of the training set that is compared to the test set of the series at 208. The forecast error from the best model (that is, the model with the best accuracy) can be used to calculate a sample forecastability metric for the training set at 210.

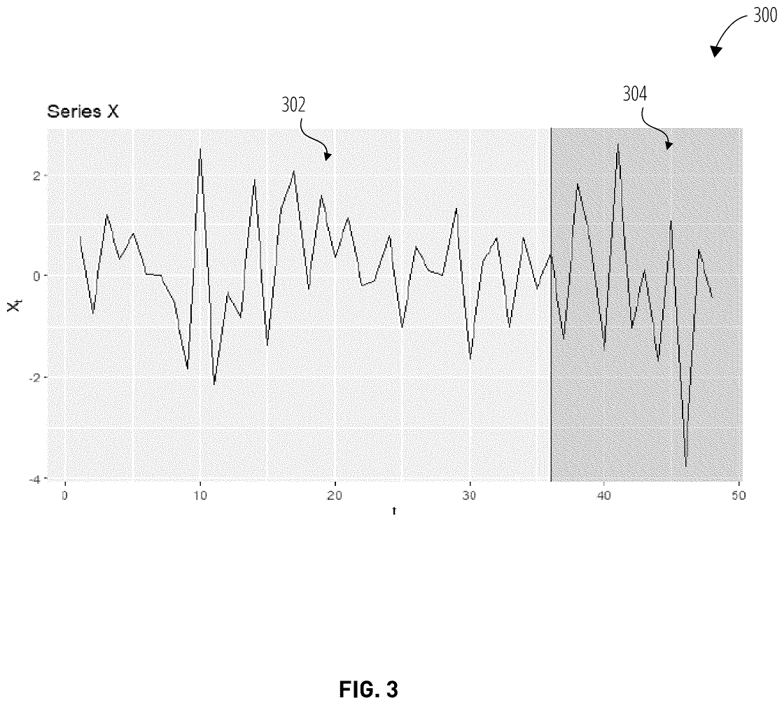

The same training set is also used to generate features of the training set at 212, resulting in features paired with a corresponding forecastability metric (from 210), for the series. Computed features can describe the behavior of a given time series. Such paired data is computed for each time series in the entire set; the pairs are then used to train machine learning models at 214, which is then used for forecastability prediction and insights at 216. The various steps shown in overview 200 are further described in FIG. 3-FIG. 7.

FIG. 3 illustrates partitioning 300 of a time series in accordance with one embodiment.

Each time series is partitioned into a consecutive training set 302 and a test set 304. The test set 302 can act as a proxy for future observations, enabling measurement of forecastability on the future. A plurality of candidate machine learning models can be fit onto training set 302; the forecast error from the best model (that is, the model with the best accuracy) can be used to calculate a sample forecastability metric of the trained portion of time series.

Output from this step can be a sample forecastability metric for the training set of each series, as shown in the following table:

| Series | Forecastability (denoted by [symbol] ) |
|---|---|
| {X₁, X₂, . . . , X_{Train End}_{_{X}}} | [symbol] _{X} |
| {Y₁, Y₂, . . . , Y_{Train End}_{_{Y}}} | [symbol] _{Y} |
| . . . | . . . |

Note that these forecastability metrics only correspond to the sample forecastability of the training set of the series, and not the entire series.

Methods and systems disclosed herein can include a training step and a step for generating the forecastability of a new time series.

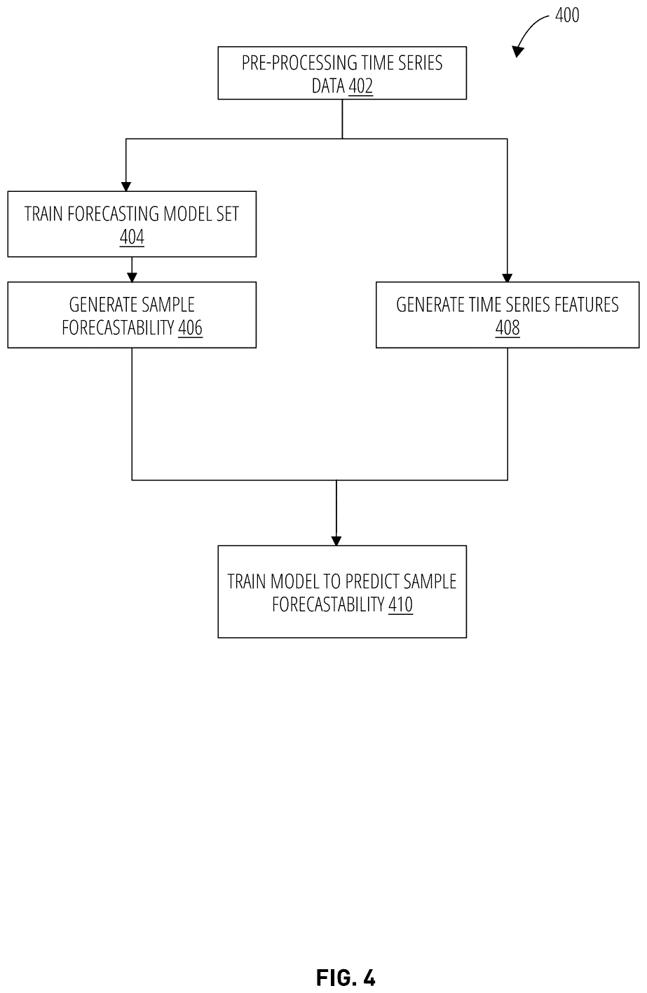

The training step can use time series data and a forecasting model set to compute sample forecastability, followed by using the time series data to generate time series features, and then uses the previously generated sample forecastability and time series features to train a model to predict the sample forecastability. The step used to predict the forecastability of new time series, can encompass generation of features for the new time series, after which, the features are passed into the model from the Training Step, which then outputs sample forecastability predictions for the new time series. Each step is described further below, with reference to FIG. 4.

FIG. 4 illustrates a block diagram 400 for machine learning training in accordance with one embodiment. A processor executes the various steps illustrated in block diagram 400. At block 402, a large set of time series data, which can be sourced from internal, external and simulated data, is preprocessed. Pre-processing, at block 402, can involve any combination of the following:
1) A series with at least one negative value is removed
2) A series with less than a preset minimum number of periods of data are removed. In some embodiments, that minimum number can be 24, and can signify, for example, months.
3) A series with greater than a preset maximum number of periods of data are randomly partitioned into a smaller set of time series. The partition size has a minimum equal to the preset minimum described above, and a maximum equal to the preset maximum. This way, all the preprocessed series have a length between the preset minimum and the preset maximum. In some embodiments, the preset minimum is 24, and the preset maximum is 96.
4) A series with a significant number of leading zeros have those zeros partially trimmed.
5) A series with a significant number of trailing zeros are completely removed.

Pre-processing can also include: normalization techniques in which z-score normalization or min-max scaling can be applied to standardize time series values; outlier detection, in which statistical methods (for example, Inter Quartile Range, Grubbs' test) or machine learning (for example, Isolation Forest) can be used to detect and optionally remove anomalies; seasonal adjustment, in which STL (Seasonal and Trend decomposition using Locally Estimated Scatterplot Smoothing) can be applied to separate seasonal components before feature extraction; and missing value imputation, in which interpolation (linear, spline) or model-based imputation (e.g., Kalman filter) van be used for incomplete series.

At block 404, the preprocessed time series dataset and the forecasting model set can be used to compute a sample forecastability for each series. The forecasting model set can be composed of following models: AutoArima, Exponential Smoothing (ETS), Complex Exponential Smoothing (CES), Theta Method, Croston's Method, Intermittent Seasonal Exponential Smoothing (ISES), Intermittent Demand Averaging (IDA), Extreme Gradient Boosting (XGB), Support Vector Regression (SVR), Linear Regression (LR), and Time-series Dense Encoder (TiDE). Additional techniques can include deep learning models (for example, Long Short-Term Memory, Gated Recurring Unit, transformer-based models, and so on); hybrid models that combine statistical and machine learning models (for example, ARIMA and XGB); and a model selection strategy that can using rolling-origin evaluation or time series cross-validation to select optimal models per series.

At block 406, sample forecastability is generated. The sample forecastability of a time series is defined as the minimum scaled loss (on a holdout test set of horizon ‘h’) from all the models in the forecast model set. This can be interpreted as using one realization of the best loss to estimate the expected best loss. Technical additions can include: loss functions where multiple metrics (for example, Mean Absolute Scaled Error (MASE), Symmetric Mean Absolute Percentage Error (sMAPE), Root Mean Squared Error (RSME)) can be used and aggregated via weighted scoring; uncertainty quantification that can include prediction intervals and confidence bounds to assess forecast reliability; and robustness testing in which adversarial perturbations or edge-case scenarios can be introduced to evaluate model stability.

At block 408, the time series data is used again to generate time series features. The features are computed on the training set of each series (that is, ignoring the holdout test set). Computed features can include the following categories: decomposition, autocorrelation, distribution, extreme value, trajectory, and intermittent.

Decomposition features can additively decompose a time series into a trend, seasonal and remainder component (using STL) and describe their respective behaviour. Autocorrelation features can measure the extent of a linear relationship between lagged values. Many time series exhibit autocorrelation and certain models can leverage this characteristic to produce forecasts. Distribution features can view a time series as being sampled from one distribution, and aim to describe the shape of that distribution; such features can be derived from a histogram of the series. Extreme value features can describe the magnitudes and locations of extreme values in the series. Trajectory features can describe the path the series takes through time. Intermittent time series are series in which the process for generating 0 values is considered separate from that of the non-zero values; intermittent features look at describing the series from this perspective.

These features can be computed using, for example, the following packages in R: tsfeatures, Rcatch22 and fabletools. Technical additions can include: spectral features, where FFT (Fast-Fourier Transforms) can be used to extract dominant frequencies and spectral entropy; complexity measures that can include permutation entropy, sample entropy, and fractal dimension; Shape-Based Features, where SAX (Symbolic Aggregate approximation) or DTW (Dynamic Time Warping) can be used for shape similarity; and Lag Features such as autocorrelation, partial autocorrelation, and lagged values.

Finally, at block 410, the previously-generated sample forecastability (at block 406) and the time series features (generated at block 408) are used to train a set of candidate models to predict forecastability. The best performing model is selected to predict the forecastability of new time series, based on features of the new time series. This approach enables application of the trained model to sets of new time series, without explicitly computing the forecastability of each new time series. This is advantageous since the computation of the forecastability of each new time series is a computationally expensive task. Another advantage is that the entire data of the new time series is used to generate features (that are used in the trained model), without omitting recent data since there is no need to split the data into a training set and test set to compute the forecastability. The resulting predicted forecastability is based on the entire data of the new time series data, leading to greater reliability. The output from this step is a trained machine learning model capable of predicting the forecastability of a new time series.

Candidate machine learning models can include Extreme Gradient Boosting (XGB), Light Gradient Boosting Machine (LGBM), and linear Support Vector Regression (SVR). The machine learning model trained and selected at block 410 can be a Light Gradient Boosting Machine (LGBM); the LGBM model, and its hyperparameters, can be selected via Bayesian Cross Validation. Technical Additions can include training a model ensemble, in which LGBM can be combined with Random Forest, CatBoost, and Neural Networks for ensemble predictions. In addition, feature selection can include use of SHAP values or Recursive Feature Elimination (RFE) to select impactful features. Hyperparameter optimization can include use of Optuna or Hyperopt for a more efficient search.

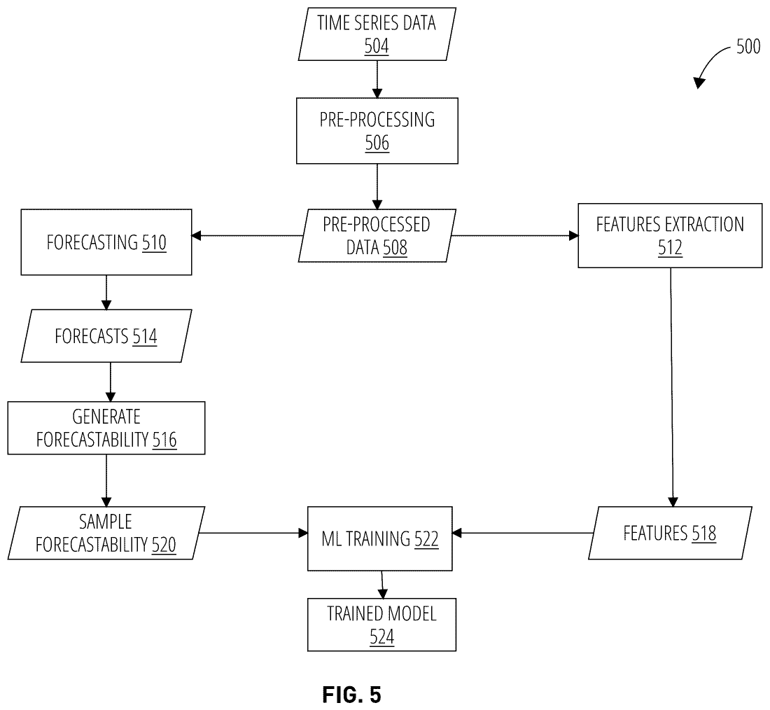

FIG. 5 illustrates data flow 500 in a training phase in accordance with one embodiment. With reference to the training phase shown in FIG. 4, a large set of time series data is input, with a trained machine learning model for forecastability prediction as output.

In FIG. 5, time series data 504 undergoes pre-processing at block 506, resulting in an output of pre-processed data 508. Pre-processing 506 can include filtering, trimming, partitioning, and cleansing the data. Pre-processed data 508 then undergoes two processes: generation of forecastability and features generation.

Generation of forecastability begins with inputting pre-processed data 508 into a forecasting model set at forecasting 510. Models such as AutoARIMA, ETS, TiDE, and the like, can be used to generate forecasts at forecasting 510. The output are forecasts 514 which are then input into a sample forecastability generator to generate forecastability 516, in which minimum scaled loss across models is computed, resulting in sample forecastability 520.

Pre-processed data 508 also undergoes features extraction 512, which can extract statistical, spectral, and shape-based features, resulting in features 518. The sample forecastability 520 and features 518 are then used for machine learning training at block 522 to provide a trained model 524 for predicting forecastability.

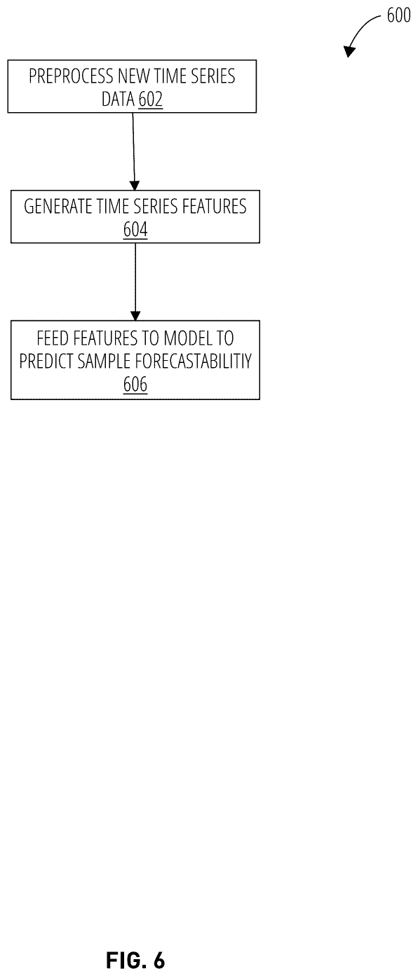

FIG. 6 illustrates a block diagram 600 for generating the forecastability of new time series in accordance with one embodiment. At block 602, incoming new time series data is preprocessed. Pre-processing, at block 602, can apply the same cleaning logic as the training phase shown in FIG. 4. As such, it can involve any combination of the following: a series with less than the preset minimum number of periods of data is removed; a series with greater than the preset maximum number of periods of data are trimmed, as described above; end of life series are removed; and leading zeros are partially trimmed using the same logic as in the training set.

Next, at block 604, time series features are generated for the preprocessed data obtained at block 602. The features generation can be executed in the same manner as in the Training Step described with reference to FIG. 4. As such, these features can be computed using, for example, the following packages in R: tsfeatures, Rcatch22 and fabletools. Technical additions can include: spectral features, where FFT (Fast-Fourier Transforms) can be used to extract dominant frequencies and spectral entropy; complexity measures that can include permutation entropy, sample entropy, and fractal dimension; Shape-Based Features, where SAX (Symbolic Aggregate approXimation) or DTW (Dynamic Time Warping) can be used for shape similarity; and Lag Features such as autocorrelation, partial autocorrelation, and lagged values.

These features are then passed into the model from block 410 of the Training Step, which then outputs the sample forecastability predictions with respect to the new time series at block 606.

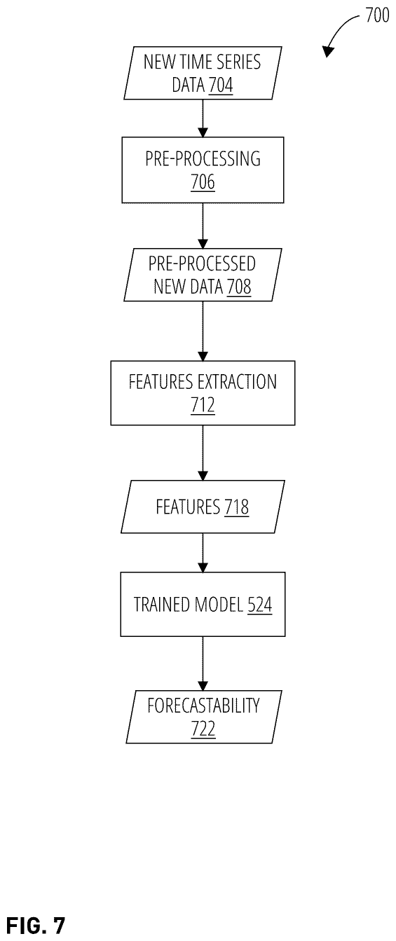

FIG. 7 illustrates data flow 700 in a prediction phase accordance with one embodiment. With reference to the training phase shown in FIG. 5, a new time series data is input, with a forecastability of the new time series data as output.

In FIG. 7, new time series data 704 undergoes pre-processing at block 706, resulting in an output of pre-processed new data 708. Pre-processing 706 can include filtering, trimming, partitioning, and cleansing the data, similar to the cleaning logic used in the training phase in block 506 in the training phase (FIG. 5).

Pre-processed new data 708 then undergoes features extraction 712, in which features 718 are generated using the same methods and tools as in block 512 of the training phase (FIG. 5). Features 718 are input into trained model 524 (from FIG. 5) to predict forecastability 722.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computing apparatus comprising:
a processor; and
a memory storing instructions that, when executed by the processor, configure the apparatus to:
receive a plurality of time series data;
preprocess the time series data to generate preprocessed time series data, wherein preprocessing comprises one or more operations selected from the group consisting of filtering, trimming, partitioning, normalization, and outlier handling;
train a plurality of forecasting models on each of the preprocessed time series data;
compute a forecastability metric for each time series based on performance of each of the forecasting models;
extract a set of features from the preprocessed time series data;
train a set of predictive models using the extracted features and the forecastability metric to learn a mapping from features to forecastability;
select a predictive model based prediction accuracy;
receive a new time series data;
preprocess the new time series data using identical or similar preprocessing operations applied to the training data, to generate a preprocessed new time series data;
extract features from the preprocessed new time series data; and
predict a forecastability score for the new time series data using the predictive model.

2. The computing apparatus of claim 1, wherein when preprocessing, the apparatus is further configured to:
remove time series that have fewer than a preset minimum number of periods;
partition time series that have more than a preset maximum number of periods into smaller segments; and
trim leading zeros and removing trailing zeros from the time series data.

3. The computing apparatus of claim 1, wherein the plurality of forecasting models comprises models selected from the group consisting of AutoARIMA, Exponential Smoothing (ETS), Complex Exponential Smoothing (CES), Theta Method, Croston's Method, Intermittent Seasonal Exponential Smoothing (ISES), Intermittent Demand Averaging (IDA), Extreme Gradient Boosting (XGB), Support Vector Regression (SVR), Linear Regression (LR), and Time-series Dense Encoder (TiDE).

4. The computing apparatus of claim 1, wherein the sample forecastability score is computed as the minimum scaled loss across the forecasting model set on a holdout test set of a defined forecast horizon.

5. The computing apparatus of claim 1, wherein predictive model is a Light Gradient Boosting Machine (LGBM) trained using Bayesian cross-validation for hyperparameter optimization.

6. The computing apparatus of claim 1, wherein the set of features includes at least one of decomposition, autocorrelation, distribution, extreme value, trajectory, and intermittent.

7. A non-transitory computer-readable storage medium, the computer-readable storage medium including instructions that when executed by a computer, cause the computer to:
receive a plurality of time series data;
preprocess the time series data to generate preprocessed time series data, wherein preprocessing comprises one or more operations selected from the group consisting of filtering, trimming, partitioning, normalization, and outlier handling;
train a plurality of forecasting models on each of the preprocessed time series data;
compute a forecastability metric for each time series based on performance of each of the forecasting models;
extract a set of features from the preprocessed time series data;
train a set of predictive models using the extracted features and the forecastability metric to learn a mapping from features to forecastability;
select a predictive model based on prediction accuracy;
receive a new time series data;
preprocess the new time series data using identical or similar preprocessing operations applied to the training data, to generate a preprocessed new time series data;
extract features from the preprocessed new time series data; and
predict a forecastability score for the new time series data using the predictive model.

8. The non-transitory computer-readable storage medium of claim 7, wherein when preprocessing, the instructions further configure the computer to:
remove time series that have fewer than a preset minimum number of periods;
partition time series that have more than a preset maximum number of periods into smaller segments; and
trim leading zeros and removing trailing zeros from the time series data.

9. The non-transitory computer-readable storage medium of claim 7, wherein the plurality of forecasting models comprises models selected from the group consisting of AutoARIMA, Exponential Smoothing (ETS), Complex Exponential Smoothing (CES), Theta Method, Croston's Method, Intermittent Seasonal Exponential Smoothing (ISES), Intermittent Demand Averaging (IDA), Extreme Gradient Boosting (XGB), Support Vector Regression (SVR), Linear Regression (LR), and Time-series Dense Encoder (TiDE).

10. The non-transitory computer-readable storage medium of claim 7, wherein the sample forecastability score is computed as the minimum scaled loss across the forecasting model set on a holdout test set of a defined forecast horizon.

11. The non-transitory computer-readable storage medium of claim 7, wherein the predictive model is a Light Gradient Boosting Machine (LGBM) trained using Bayesian cross-validation for hyperparameter optimization.

12. The non-transitory computer-readable storage medium of claim 7, wherein the set of features includes at least one of decomposition, autocorrelation, distribution, extreme value, trajectory, and intermittent.

13. A computer-implemented method comprising:
receiving, by a processor, a plurality of time series data;
preprocessing, by the processor, the time series data to generate preprocessed time series data, wherein preprocessing comprises one or more operations selected from the group consisting of filtering, trimming, partitioning, normalization, and outlier handling;
training, by the processor, a plurality of forecasting models on each of the preprocessed time series data;
computing, by the processor, a forecastability metric for each time series based on performance of each of the forecasting models;
extracting, by the processor, a set of features from the preprocessed time series data;
training, by the processor, a set of predictive models using the extracted features and the forecastability metric to learn a mapping from features to forecastability;
selecting, by the processor, a predictive model based on prediction accuracy;
receiving, by the processor, a new time series data;
preprocessing, by the processor, the new time series data using identical or similar preprocessing operations applied to the training data, to generate a preprocessed new time series data;
extracting, by the processor, features from the preprocessed new time series data; and
predicting, by the processor, a forecastability score for the new time series data using the predictive model.

14. The computer-implemented model of claim 13, wherein preprocessing further comprises at least one of:
removing, by the processor, time series that have fewer than a preset minimum number of periods;
partitioning, by the processor, time series that have more than a preset maximum number of periods into smaller segments; and
trimming, by the processor, leading zeros and removing trailing zeros from the time series data.

15. The method of claim 13, wherein the plurality of forecasting models comprises models selected from the group consisting of AutoARIMA, Exponential Smoothing (ETS), Complex Exponential Smoothing (CES), Theta Method, Croston's Method, Intermittent Seasonal Exponential Smoothing (ISES), Intermittent Demand Averaging (IDA), Extreme Gradient Boosting (XGB), Support Vector Regression (SVR), Linear Regression (LR), and Time-series Dense Encoder (TiDE).

16. The method of claim 13, wherein the sample forecastability score is computed as the minimum scaled loss across the forecasting model set on a holdout test set of a defined forecast horizon.

17. The method of claim 13, wherein the predictive model is a Light Gradient Boosting Machine (LGBM) trained using Bayesian cross-validation for hyperparameter optimization.

18. The method of claim 13, wherein the set of features includes at least one of decomposition, autocorrelation, distribution, extreme value, trajectory, and intermittent.
